(19) United States
(12) Patent Application Publication
(10) Pub. No.: US 2015/0112764 A1
(43) Pub. Date: Apr. 23, 2015

(54) Automated Evaluation of Transaction Plays

(71) Applicants: SEBASTINE AUGUSTINE, Palo Alto, CA (US); PRERNA MAKANAWALA, Palo Alto, CA (US); KEDAR SHIROOR, Palo Alto, CA (US); ABHIJIT MITRA, Palo Alto, CA (US); KARAN SOOD, Palo Alto, CA (US)

(72) Inventors: SEBASTINE AUGUSTINE, Palo Alto, CA (US); PRERNA MAKANAWALA, Palo Alto, CA (US); KEDAR SHIROOR, Palo Alto, CA (US); ABHIJIT MITRA, Palo Alto, CA (US); KARAN SOOD, Palo Alto, CA (US)

(73) Assignee: SAP AG, Walldorf (DE)

(21) Appl. No.: 14/058,021

(22) Filed: Oct. 18, 2013

(51) Int. Cl. G06Q 30/02

(52) U.S. Cl. CPC G06Q 30/0202
USPC 705/7.31

(57) ABSTRACT

In one embodiment, a computer-implemented method comprises generating, using a computer, recommendations of a first group of products of a plurality of products based on past transactions between a plurality of persons and a plurality of entities for the plurality of products, relationships between the persons, relationships between the entities, and relationships between the persons and the entities; generating, using the computer, a score for each recommendation of the plurality of recommendations; and generating, using the computer, a first success indicator of a first selected recommendation based on the score associated with the first selected recommendation.

### BACKGROUND

Embodiments relate to the analysis of business information, and in particular to systems and methods configured to automatically evaluate transaction plays.

Unless otherwise indicated herein, the approaches described in this section are not prior art to the claims in this application and are not admitted to be prior art by inclusion in this section.

Business entities are continuously seeking to evaluate potential business transactions. Such business transactions often arise within the context of existing client relationships. Often information related to the existing client relationship is analyzed based only on past sales with the client or only on the business relationship with the client.

Accordingly, there is a need in the art for systems and methods that allow automated evaluation of transaction plays.

### SUMMARY

Embodiments improve automated evaluation of transaction plays. In one embodiment, a computer-implemented method comprises generating, using a computer, recommendations of a first group of products of a plurality of products based on past transactions between a plurality of persons and a plurality of entities for the plurality of products, relationships between the persons, relationships between the entities, and relationships between the persons and the entities; generating, using the computer, a score for each recommendation of the plurality of recommendations; and generating, using the computer, a first success indicator of a first selected recommendation based on the score associated with the first selected recommendation.

In various embodiments, generating recommendations includes generating recommendations based on past transactions, contextual influencing factors, and global influencing factors.

In various embodiments, generating a first success indicator includes generating a first success indicator based on past transactions and global influencing factors.

In various embodiments, the scores are indicative of a probability of success of the recommendations.

In various embodiments, the past transactions include won transactions and lost transactions, and generating a score includes generating a score based on win rate.

In various embodiments, the method further comprises generating, using the computer, a second success indicator of a second selected recommendation based on the score associated with the second selected recommendation; and displaying, using the computer, the first success indicator, the second success indicator, and the products, people and entities associated with the second recommendation.

In various embodiments, generating a score for each recommendation includes applying a predictive model to each recommendation to generate a corresponding score.

In various embodiments, the selected recommendations are sales plays.

In various embodiments, a non-transitory computer readable storage medium embodying a computer program performs a method comprising: generating, using a computer, recommendations of a first group of products of a plurality of products based on past transactions between a plurality of persons and a plurality of entities for the plurality of products, relationships between the persons, relationships between the entities, and relationships between the persons and the entities; generating, using the computer, a score for each recommendation of the plurality of recommendations; and generating, using the computer, a first success indicator of a first selected recommendation based on the score associated with the first selected recommendation.

In one embodiment, a computer system comprises one or more processors and a software program, executable on the computer system. The software program is configured to generate recommendations of a first group of products of a plurality of products based on past transactions between a plurality of persons and a plurality of entities for the plurality of products, relationships between the persons, relationships between the entities, and relationships between the persons and the entities; generate a score for each recommendation of the plurality of recommendations; and generate a first success indicator of a first selected recommendation based on the score associated with the first selected recommendation.

The following detailed description and accompanying drawings provide a better understanding of the nature and advantages of the embodiments described herein.

### BRIEF DESCRIPTION OF THE DRAWINGS

FIG. 1 illustrates a high level system according to one embodiment.

FIG. 2 illustrates a system according to one embodiment.

FIG. 3 illustrates a deal playbook engine of the system of FIG. 2 according to one embodiment.

FIG. 4 is a simplified diagram illustrating a process flow for generating a sorted list of recommendations of sales items according to an embodiment.

FIG. 5 is a simplified diagram illustrating a process flow for calculating a success indicator of a sales transaction according to an embodiment.

FIG. 6 is an example display of a landing page of a deal playbook engine according to an embodiment.

FIG. 7 is an example display of a landing page of a deal playbook engine upon selection of a first play according to an embodiment.

FIG. 8 is an example display of recommended sales items according to an embodiment.

FIG. 9 is an example display of recommended sales items and detailed information for a selected sales item according to an embodiment.

FIG. 10 is an example display of deal playbook upon selection of a second play according to an embodiment.

FIG. 11 is a simplified diagram illustrating a process flow for calculating a score of a recommended sales item according to an embodiment.

FIG. 12 is a simplified diagram illustrating a process flow for calculating a success indicator by a predictive analysis engine according to another embodiment.

FIG. 13 is a simplified diagram illustrating a data flow for calculating a success indicator of a transaction according to an embodiment.

FIG. 14 illustrates an example of a computer system.

### DETAILED DESCRIPTION

Described herein are techniques for automated evaluation of transaction plays. In the following description, for purposes of explanation, numerous examples and specific details are set forth in order to provide a thorough understanding of the embodiments described herein. It will be evident, however, to one skilled in the art that the present invention as defined by the claims may include some or all of the features in these examples alone or in combination with other features described below, and may further include modifications and equivalents of the features and concepts described herein.

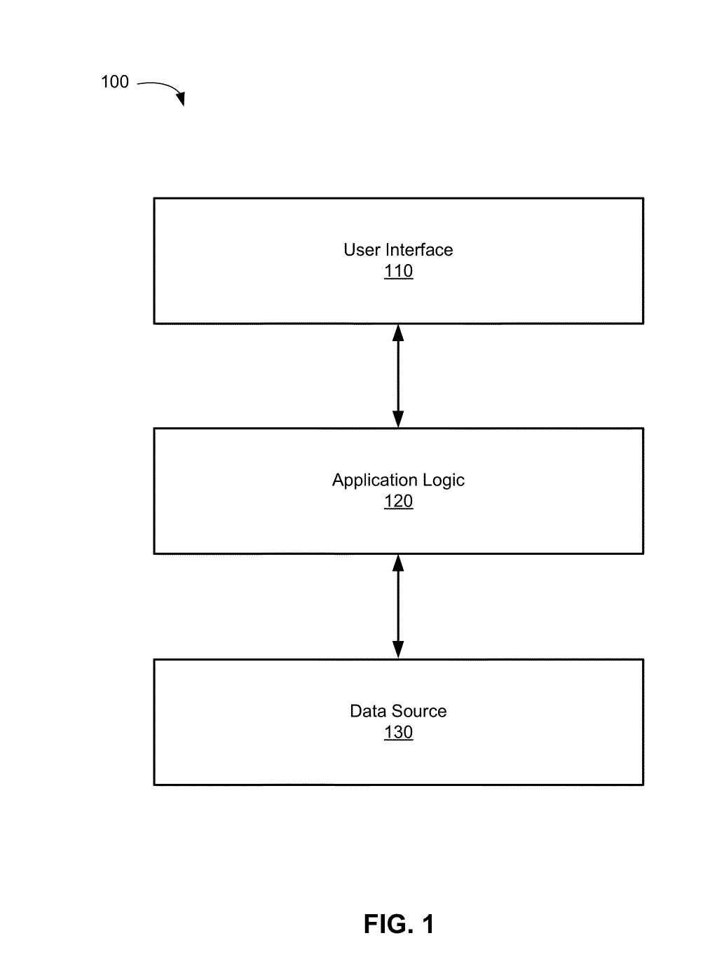

FIG. 1 illustrates a high level system 100 according to one embodiment. System 100 is an application implemented in computer code that can be executed on the server side, the client side, or a combination of both. In one embodiment, system 100 is executed using a plurality of computers communicating with one another via the Internet to provide sales tools in the cloud for selling sales items. A sales item can be a product or service that is placed on sale or available for license. For example, a product for sale can be a pharmaceutical drug, a service for sale can be housekeeping services, and a product for license can be a software license for a software application. Each sales tool can be configured for a different phase of the sales process. In some embodiments, the sales tools provided can include identifying sales opportunities to sell sales items to customers, predicting the outcome of a given sales opportunity, identifying key decision maker for a sales opportunity, and recommending influential people that can help convert the sales opportunity into a successful sales deal.

System 100 includes user interface layer 110, application logic layer 120, and data source layer 130. Data source layer 130 includes a variety of data sources containing data that is analyzed by sales tools stored in application logic layer 120. In one example, data source layer 130 includes data about a company. This can include information about the sales force of the company, information about the sales items that the company offers for sale, and information about customers of the company. In another example, data source layer 130 includes data about sales opportunities. This can include information about potential customers and existing customers, such as customer needs, prior sales deals, and other data related to the customer. In yet another example, data source layer 130 includes information about salespeople outside the company. In yet other examples, other types of data related to the company, competing companies, sales items, and customers can be stored in data source layer 130. For instance, news related to sales items (e.g., recalls, updates to FDA approval, etc.) and customers (e.g., upcoming IPOs, lawsuits, etc.) can also be a part of data source 130. In some embodiments, the data sources that make up data source layer 130 can be stored both locally and remotely. For example, company sensitive information such as information about existing customers or the sales force of the company can be stored and managed in local databases that belong to the company while information about other salespeople not within the company can be periodically retrieved from a remote source such as a social networking website.

Application logic layer 120 is coupled to data source layer 130. Application logic layer 120 includes one or more sales tools that can be utilized by a sales force to help each salesperson in the sales force successfully close sales deals. The sales tools can analyze the collective knowledge available from data source layer 130 to predict the outcome of a sales opportunity. The sales tool can also provide recommendations that may improve the chance of success of the sales opportunity. In one embodiment, a sales tool can be a deal finder that helps a salesperson identify potential deals (e.g., sales opportunities) with existing and potential clients. In another embodiment, a sales tool can be a deal playbook that helps a salesperson identify the combination of sales team, sales items, and/or sales entities that would most likely lead to a successful sales deal. The sales team can include people that the salesperson directly knows and people that the salesperson does not directly know. People that the salesperson does not directly know but can improve the success rate of the sales deal are known as key influencers. In another embodiment, a sales tool can be a spiral of influence that identifies people who can potentially influence the outcome of the sales opportunity. In one example, this can include the key influencers mentioned above. In another example, the spiral of influence can evaluate relationships between the salesperson and a key influencer to identify people who can potentially introduce the salesperson to the key influencer. This can include analyzing relationship information of the sales force and ranking the relationship information to derive a strength of influence for each person that can potentially introduce the given salesperson to the key influencer.

User interface layer 110 is coupled to application logic layer 120. User interface layer 110 can receive user input for controlling a sales tool in application logic layer 120. User interface layer 110 can interpret the user input into one or more instructions or commands which are transmitted to application logic layer 120. Application logic layer 120 processes the instructions and transmits the results generated from application logic layer 120 back to user interface layer 110. User interface layer 110 receives the results and presents the results visually, audibly, or both. In one embodiment, user interface layer 110 can present a landing page that presents information related to a particular user such as information on existing and future sales opportunities and sales deals. The status of sales opportunities can be monitored and tasks can be performed from the landing page.

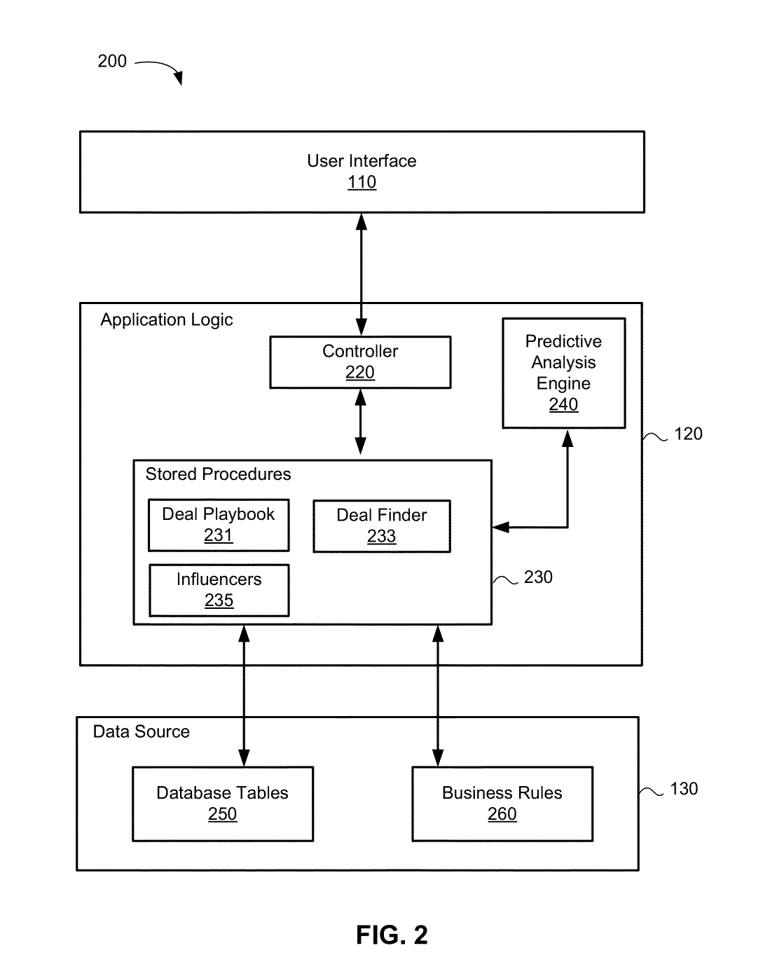

FIG. 2 illustrates a system 200 according to one embodiment. System 200 is an application implemented in computer code that can be executed on the server side, the client side, or both. For example, user interface 110 can be executed on the client while application logic 120 and data source 130 can be executed on one or more servers. System 200 can be a sales application for selling sales items. In one embodiment, system 200 includes multiple sales tools that can be combined to manage and monitor sales opportunities and sales deals. Application logic 120 includes controller 220, stored procedures 230, and predictive analysis engine 240. Controller 220 is configured to control the operations of system 200. Controller 220 receives user input from user interface 110 and translates the user input into a command which is communicated to stored procedures 230. A procedure from stored procedures 230 that corresponds with the command can be called by controller 220 to process the command. Stored procedures 230 can include a deal playbook 231, deal finder 233, influencers 235, and other sales tools.

When processing the command, the procedure (which can be one of deal playbook 231, deal finder 233, or influencers 235) can communicate with data source 130. More specifically, the procedure can retrieve data from database tables 250 and business rules 260 of data source 130 for analysis. Database tables 250 can store data in different tables according to the data type and business rules 260 can store rules to be met when stored procedures 230 processes the data in database tables 250. In one example, each database table in database tables 250 can store a type of data. The analysis performed by the procedure can include transmitting data retrieved from database tables 250 to predictive analysis engine 240 for processing. Predictive analysis engine 240 can be configured to analyze received data or rules to provide predictions. In some embodiments, the predictions can include potential sales opportunities for a particular salesperson, the outcome of a potential sales opportunity, and influential people who can help transform a sales opportunity into a successful sales deal. Once results are generated by the procedure of stored procedures 230, the results can be communicated to controller 220, which in turn communicates the results to user interface 110 for presentation to the user.

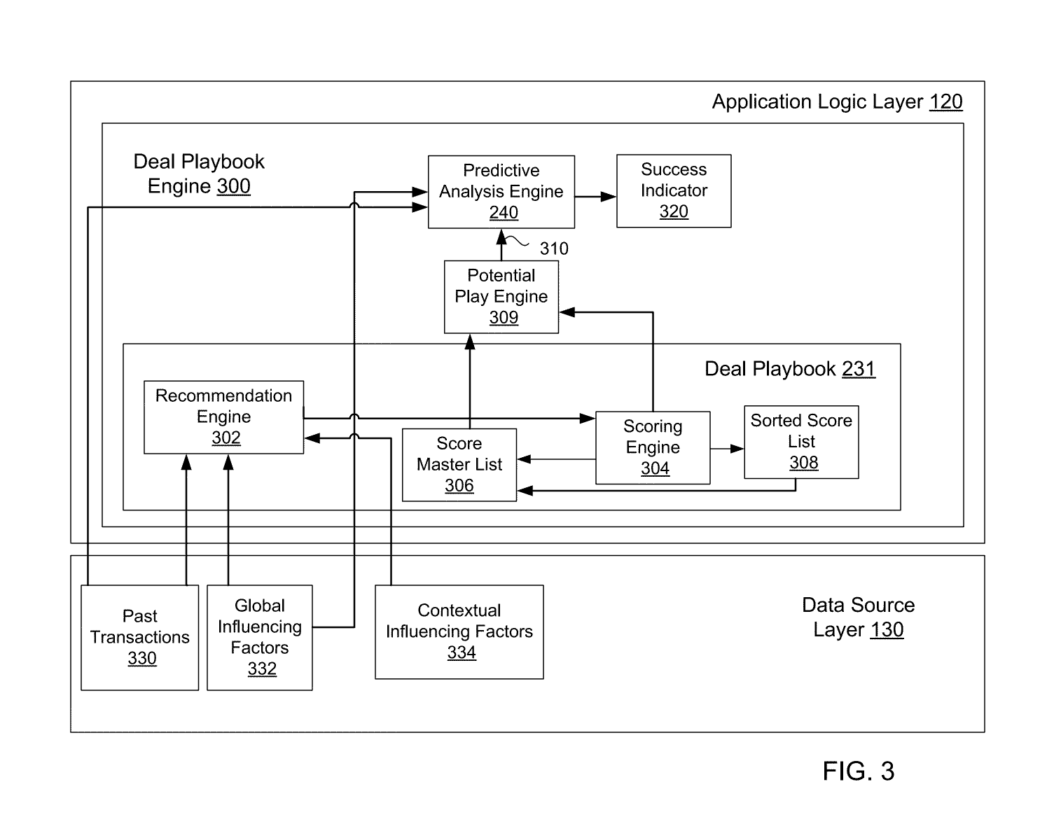

FIG. 3 illustrates deal playbook engine 300, which comprises deal playbook 231, predictive analysis engine 240, and potential play engine 309. Although predictive analysis engine 240 is shown separate from deal playbook 231, predictive analysis engine 240 can be part of deal playbook 231. Deal playbook engine 300 automatically evaluates transaction plays to help a salesperson identify the combination of sales teams, sales items, and/or sales entities that would most likely lead to a successful sales deal. Playbook engine 300 analyzes past transactions of sales items, sales teams, and sales entities to generate probabilities of success for various combinations of sales team, sales items, and/or sales entities. Playbook engine 300 enables a user, such as a sales representative, to enhance the chance of success of making a sales deal by determining the best recommended people, such as contacts and employees, to involve in the sales process, positioning the appropriate sales item, and selling via the right partner or partners.

Playbook engine 300 uses past transactions 330, global influencing factors 332, and contextual influencing factors 334 stored in data source layer 130 to analyze and generate recommendations of sales items, sales teams (e.g., persons or employees) and sales entities (e.g., partners) and to calculate success indicators 320 for the play. In some embodiments, success indicator 320 is an indicator of success of the play, such as a probability or chance of success. A play can be a plan or strategy for making a transaction successful with a prospect or a customer for a sales item or sales items in which the plan or strategy includes adding one or more sales items, one or more persons, or one or more sales entities, or any combination thereof, into the transaction.

In some embodiments, past transactions 330 constitute previous sales data of an organization or user or users of system 100. The past transactions can include data related to previous sales for sales items, first degree people related to such sales items, second degree people related to the first degree people, first degree sales entities related to such sales items or such people, and second degree sales entities related to first degree sales entities. In some embodiments, past transactions 330 determines contextual win rate and revenue.

Global influencing factors 332 can be account or customer relevant factors or transaction specific factors or both. In one embodiment, the account or customer relevant factors can include country, industry, and account classification. In one embodiment, the deal specific factors can include competitors, category of interest of the sales item, and existing sales items.

Contextual influencing factors 334 can be related to sales items, persons, or sales entities. Contextual influencing factors 334 for sales items can include whether the sales item is sold with existing sales items in the transaction, the country of the account or customer, the industry of the account or customer, the classification of the sales item, the main competitor or competitors of the sales items, and the category of the sales item. Contextual influencing factors 334 for persons or entities can include the sales item in play, the country of the account or customer, the industry of the account or customer, the classification, and the main competitor of the employee or partner.

Playbook engine 300 can generate information for user interface layer 110 to generate a single user interface that provides a unified consumption of the multiple recommendations with an associated prediction of success via success indicator 320.

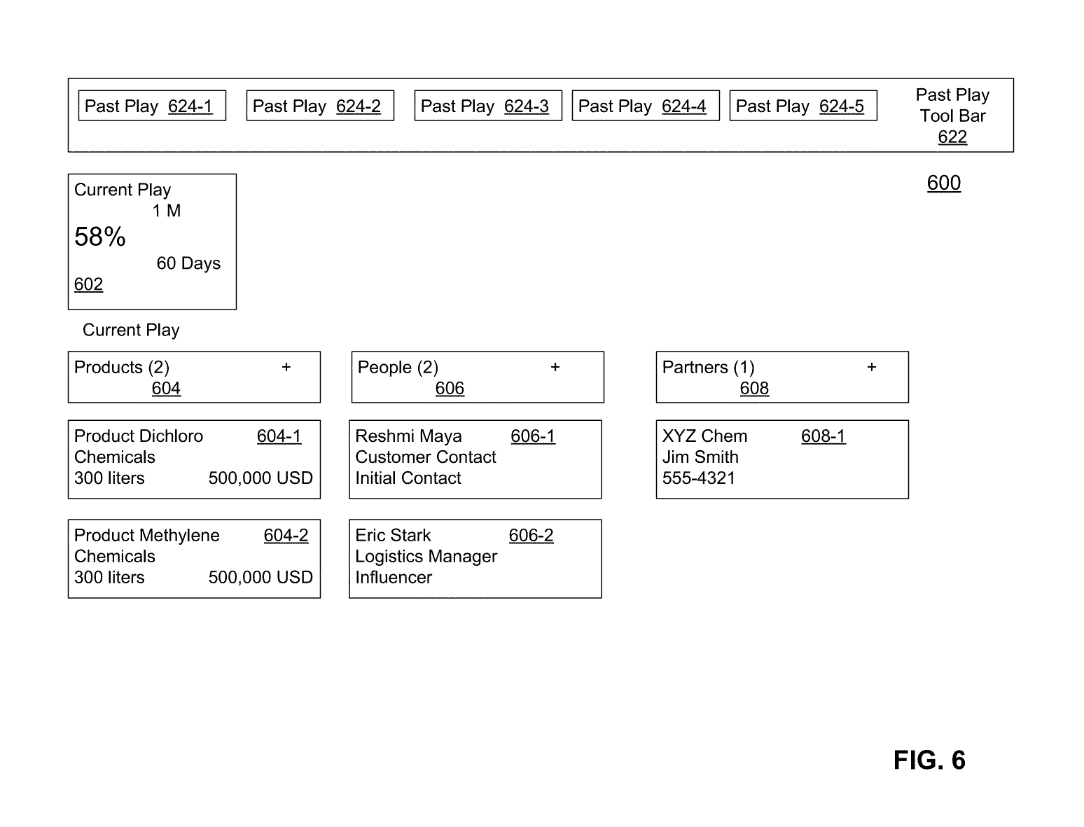

In some embodiments, playbook engine 300 generates information for user interface layer 110 to generate a display that provides a scorecard based quick view to understand the recommendation score. Illustrative examples of the quick view are shown in FIGS. 6-10, which are described below.

Playbook engine 300 can analyze multiple plays in parallel. In various embodiments, playbook engine 300 can display the recommendations in a format that provides a gaming experience of the opportunities to the user.

In some embodiments, playbook engine 300 identifies interactively recommendations based on global influencing factors 332 and contextual influencing factors 334. The interactivity can be based on modifying influencing factors weights or filtering or both. In various embodiments, the global influencing factors 332 and contextual influencing factors 334 and any associated weighting and filtering are user modifiable.

Deal playbook 231 comprises a recommendation engine 302, a scoring engine 304, a score master list 305, and a sorted score list 308.

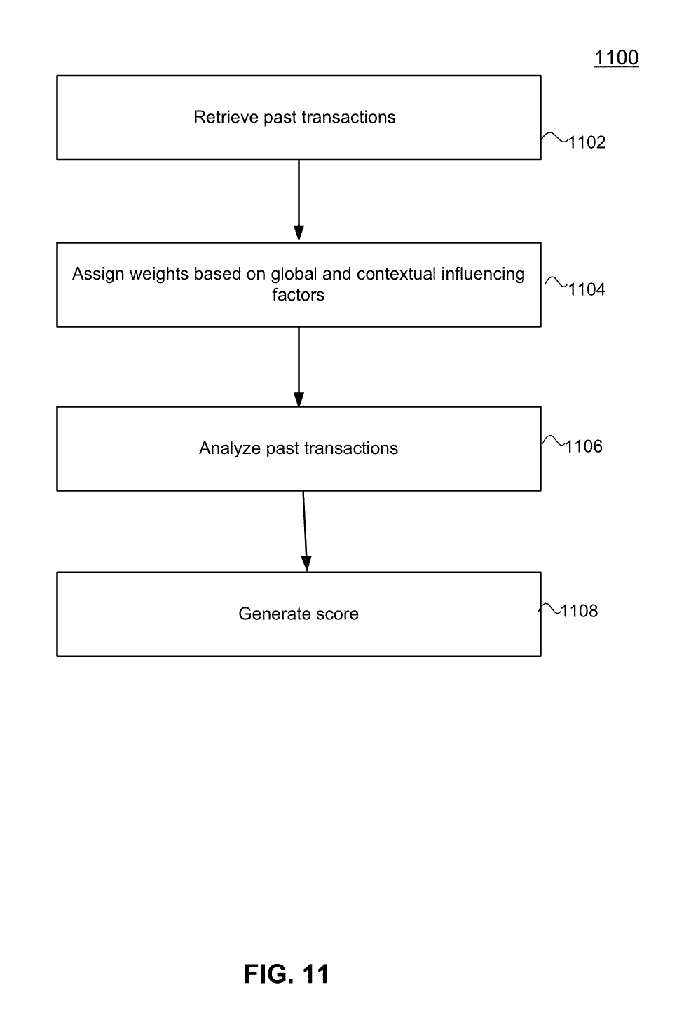

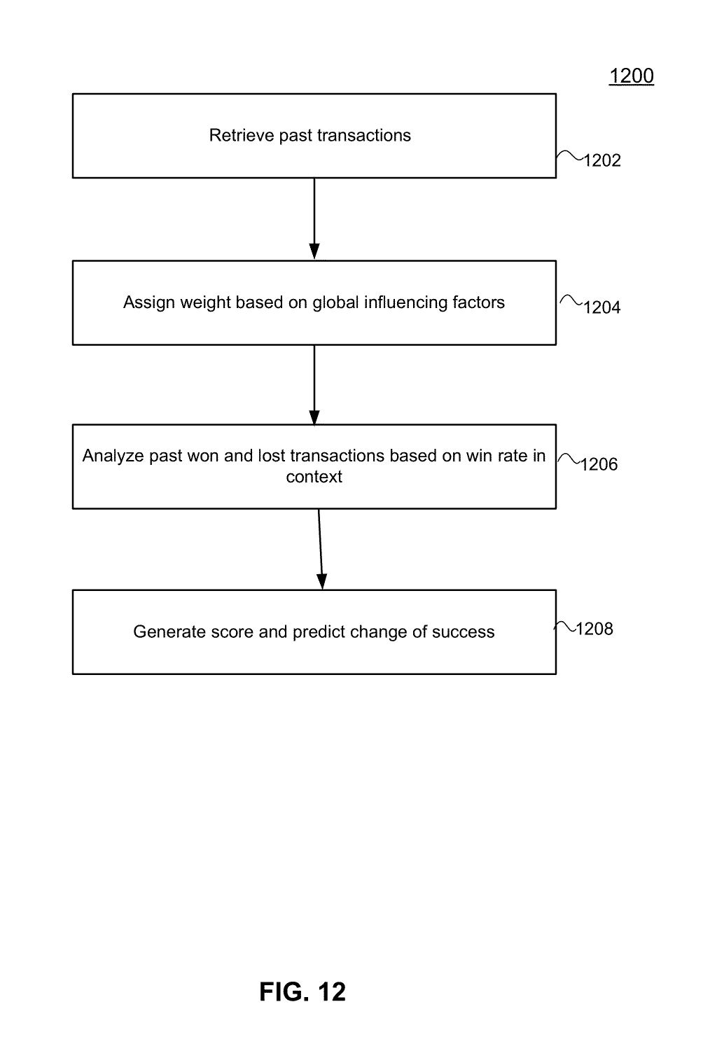

Recommendation engine 302 generates recommendations and corresponding scores of sales items, people, and entities from past transactions 330, global influencing factors 332, and contextual influencing factors 334. The scores can be generated as described below in conjunction with FIGS. 11-12. In various embodiments, recommendation engine 302 calculates, for the sales item, the size of the deal, commission of a sale or license, and time of delivery of the sales item. Although one deal playbook 231 is shown, deal playbook engine 300 can include three deal playbooks 231 to generate scores for respective sales items, persons, and sales entities that are provided for potential play 310.

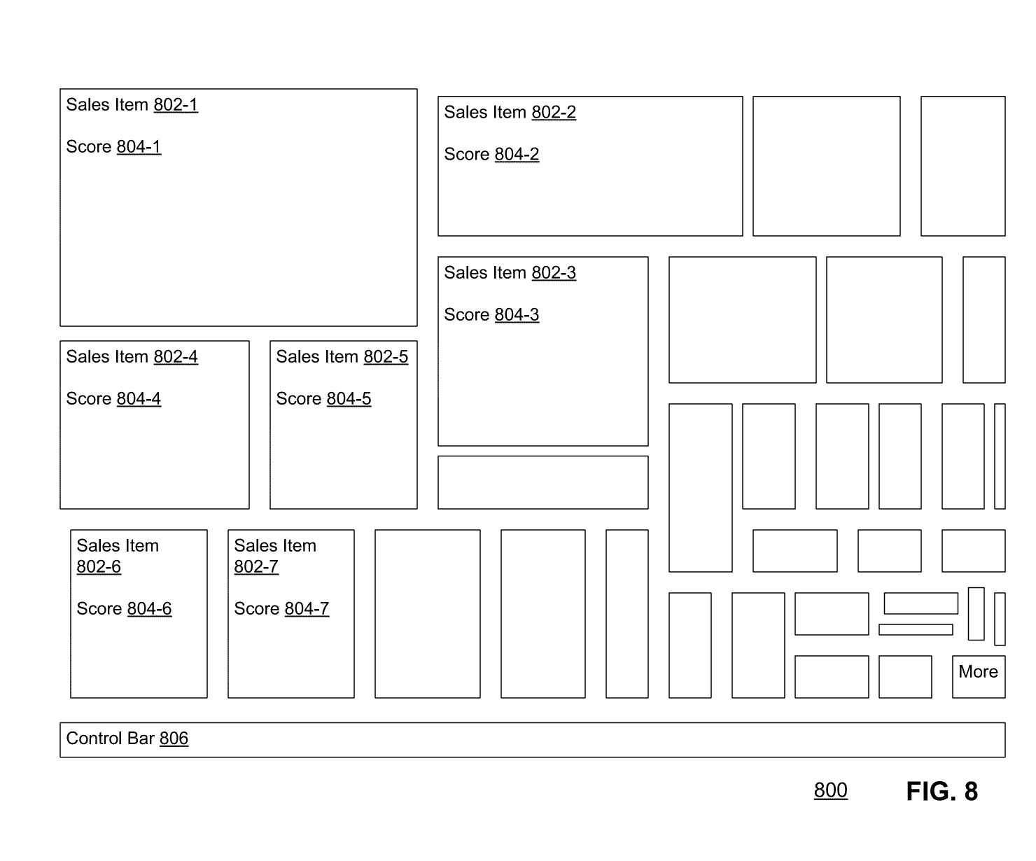

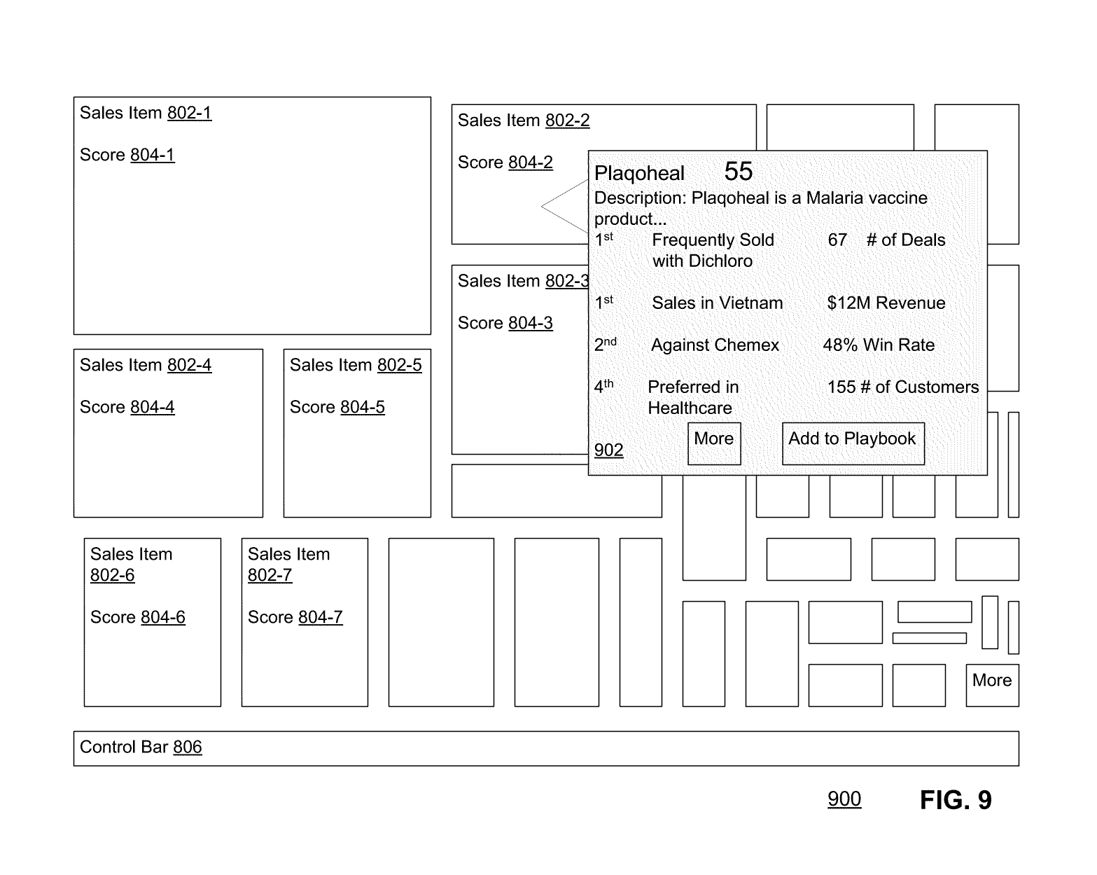

Scoring engine 304 processes the score for each recommendation from recommendation engine 302, and stores the scores in score master list 306. Sorted score list 308 is a list of the sorted recommendations by score. In some embodiments, the list is displayed as a treemap, such as shown for FIGS. 8 and 9, which are described below. Scoring engine 304 sorts the recommendations by score and generates sorted score list 308.

Playbook input engine 309 generates potential play 310 in response to a received user selection input from user interface layer 110. In some embodiments, scoring engine 304 generates potential play 310 in response to an analysis of recommendations based on user selected criteria received from user interface layer 110.

Predictive analysis engine 240 applies a predictive model to potential play 310 to generate success indicator 320 for the transaction. In various embodiments, the predictive model analyzes the codependence of past transactions 330 and global factors. In one embodiment, the global factors for the sales items include global influencing factors 332. The predictive model may be, for example, analysis of variance (ANOVA) or analysis of covariance (ANCOVA).

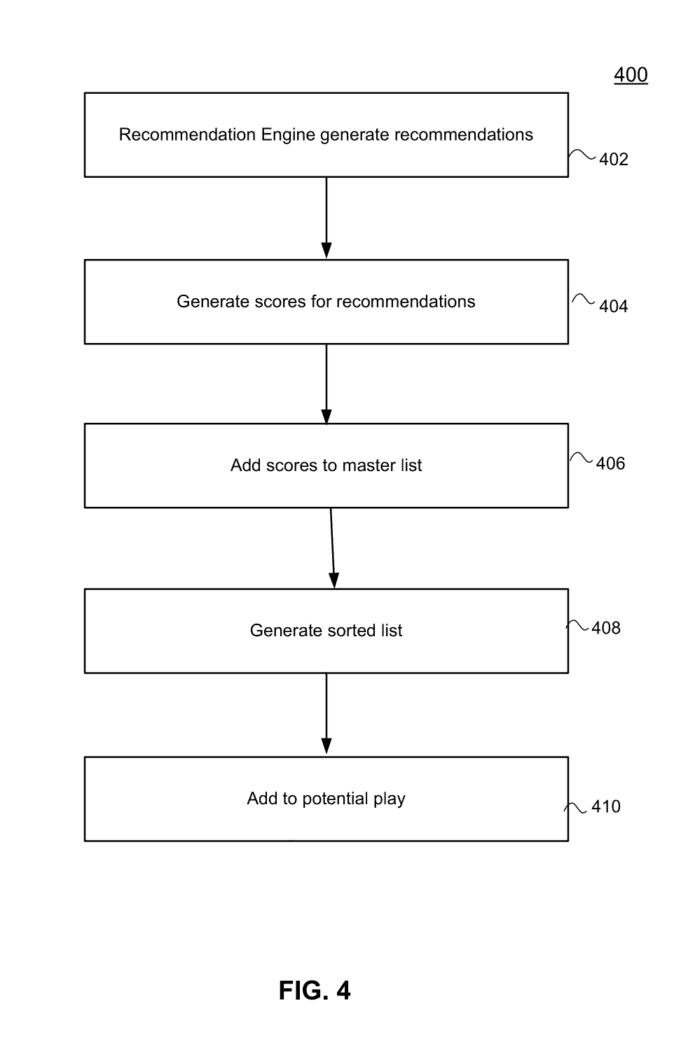

FIG. 4 is a simplified diagram illustrating a process flow 400 for generating a sorted list of recommendations of sales items according to an embodiment. For simplicity and clarity, FIG. 4 is described only for recommendations of sales items, however, recommendation engines 302 can apply process flow 400 to generate recommendations for sales teams and sales entities. At 402, recommendation engine 302 generates recommendations for sales items based on past transactions. In various embodiments, the past transactions are between the entities, between persons of the entities, and between persons and the entities. Recommendation engine 302 may generate recommendations for sales items also based on relationships between persons, relationships between entities and relationships between persons and entities.

At 404, recommendation engine 302 generates a score for the recommendation for each sales item. At 406, scoring engine 304 adds the scores to score master list 306. At 408, scoring engine 304 generates a sorted score list 308 of recommendations. At 410, scoring engine 304 adds sorted score list 308 to potential play 310.

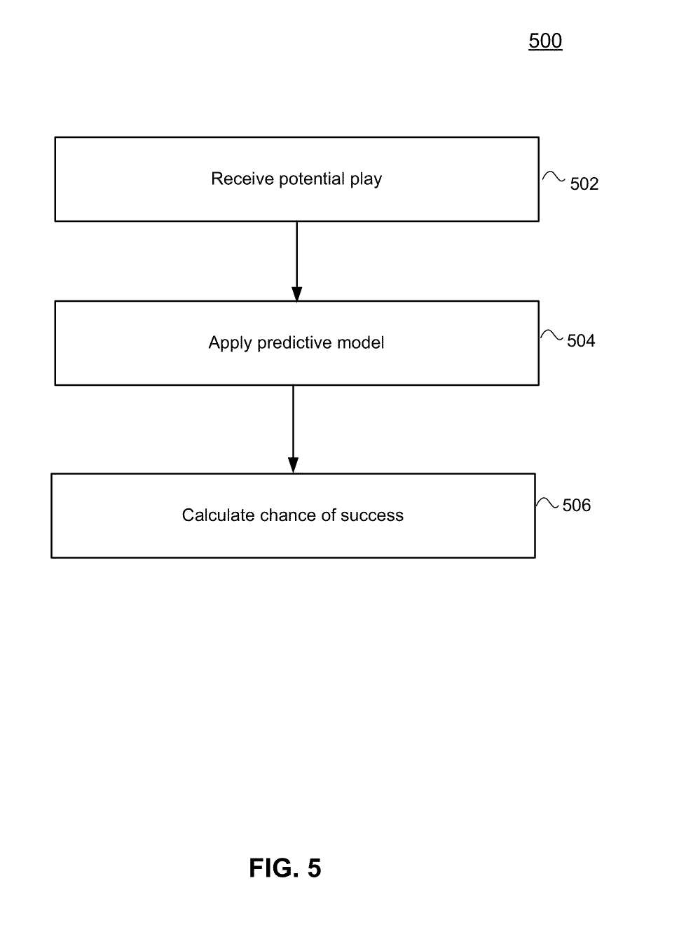

FIG. 5 is a simplified diagram illustrating a process flow 500 for calculating success indicator 320 of a sales transaction. At 502, predictive analysis engine 240 receives potential play 310 and retrieves past transactions 330 for a sales transaction At 504, predictive analysis engine 240 applies a predictive model to potential play 310 to generate success indicator 320 based on global influencing factors 332 and past transactions 330. At 506, predictive analysis engine 240 calculates success indicator 320 for the sales transaction.

FIG. 6 is an example display 600 of a landing page of playbook engine 300. Display 600 comprises a current play icon 602 that includes summary information of the current play, such as summary information of the current play as indicated by success indicator 320 (e.g., 58%), expected revenue (e.g., $1M US Dollars) and cycle time to close the deal (e.g., 60 days). The current play is based on products displayed corresponding to product icon 604, people displayed corresponding to people icon 606, and sales entities displayed corresponding to partner icon 608.

In the illustrative example shown in FIG. 6, the current play for product icon 604 is two products 604-1 and 604-2. These two products 604-1 and 604-2 are expected to generate $1M in total revenues. The current play for people icon 606 is two people 606-1 and 606-2. The current play for partner icon 608 is one partner 608-1. This illustrative example of two products (also referred to as sale items), two people and one partner has a 58% chance of success as determined by playbook engine 300.

A past play tool bar 622 comprises a plurality of past play icons 624 that represent successful past plays. Although five past play icons 624-1 through 624-5 are shown, past play tool bar 622 can include other numbers of past play icon 624. Selection of a past play icon 624, such as dragging the icon outside of past play tool bar 622, causes playbook engine 300 to evaluate the selected play. In various embodiments, the displayed past plays are based on past transactions with similarities of products, people, or partners that are ranked based on likelihood of success.

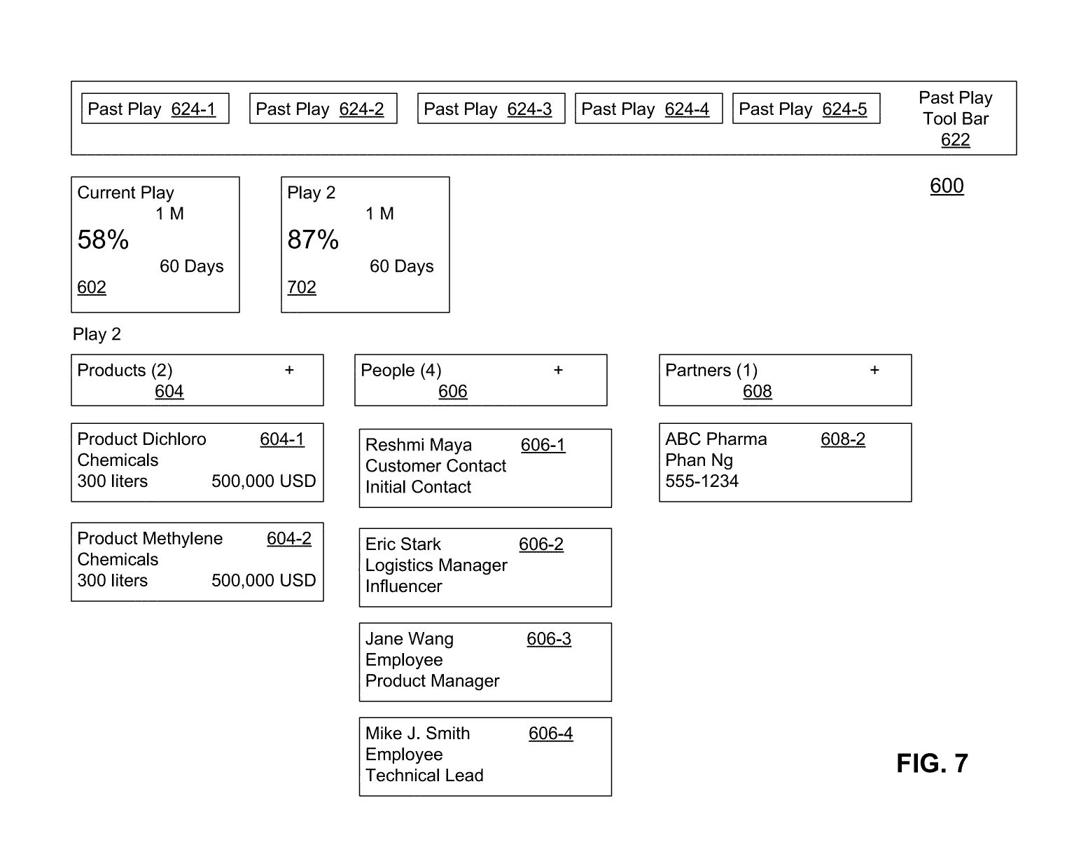

FIG. 7 is an example display 700 of a landing page of playbook engine 300 upon selection of a new second play 702 corresponding to the selected 624. The new second play 702 is for the same products 604-1 and 604-2, but with two additional people 606-3 and 606-4 and a new partner 608-2 that replaces partner 608-1. The new partner 602-2 may have, for example, more expertise with the product or more experience in the region. Second play icon 702 includes summary information of the second play, such as of the second play as indicated by success indicator 320 (e.g., 87%), expected revenue (e.g., $1M USD) and cycle time to close the deal (e.g., 60 days). The chance of success is higher, which may be due to the new partner 608-2 or the two additional people 606-3 and 606-4. The new partner 602-2 or the two additional people 606-3 and 606-4 can be deleted to allow playbook engine 300 to recalculate success indicator 320 to determine their impact on success indicator 320.

FIG. 8 is an example display 800 of recommended sales items upon selection of product icon 604 in display 700. Display 800 illustrates visualizing data in a structure of shapes known as a treemap. A treemap visualization expresses information in a two-dimensional mapping. In this example, rectangles are used to represent the mapping in two dimensions. It is to be understood that other shapes could be used. Although two-dimensions are shown, multi-dimensions may be shown using visualization hierarchy with nested rectangles.

In one embodiment, each rectangle corresponds to a sales item 802. For simplicity and clarity, only sales items 802-1 through 802-7 are labeled. In one embodiment, a treemap converts tabular data using a variety of weights and labels. The weight of a node may be determined by numerical data associated with a recommendation score 804. For simplicity and clarity, only recommendation scores 804-1 through 804-7 are labeled. Such data can used to determine the size of a treemap node's bounding shape (e.g., the size of the rectangle). A sales item 802's weight may determine the display size and may be used as a measure of importance or degree of interest. For another example, a treemap visualization may follow a list of properties to convert a sales item 802 into a visual display. In addition to setting the bounding shape of a sales item 802, other display properties such as color (hue, saturation, and brightness), shape, shading, patterns, and borders may be set. In some applications, color may be an important visual property, because it can be a fast and accurate way to acquire information and make decisions. In one embodiment, the display may be implemented by mapping content information, such as locations, attribute values, and recommendation scores 804, to display properties.

For example, if a salesperson wants to evaluate sales item 802-2, the salesperson selects sales items 802-2 and the user display layer 110 displays the display of FIG. 9.

FIG. 9 is an example display 900 that includes display 800 and a pop-up window 902 showing detailed information for the selected sales item 802-2. 902 includes the name of the selected sales item 802-2, the recommendation score 804-4 (a score of 55 in the illustrative example), data of the selected sales item 802-2, a “more” icon to obtain additional data, and an “add to playbook” icon to add the selected sales item 802-2 to the deal playbook. The data of the selected sales item 802-2 can include relationship of selected sales item with other products (e.g., frequently sold with Dichloro and quantified by number of deals or ranking), sales of the selected sales item in a country or region (e.g., sales in Vietnam and quantified by sales revenue or ranking), competitors (e.g., sales success against competitors and quantified by win rate or ranking), and information of type of users (e.g., healthcare and quantified by numbers of customers in the field of the specified type of user). Although treemaps are shown in FIGS. 8 and 9 for sales items 802, treemaps can be used for showing sales items, people or sales entities launched from other displays.

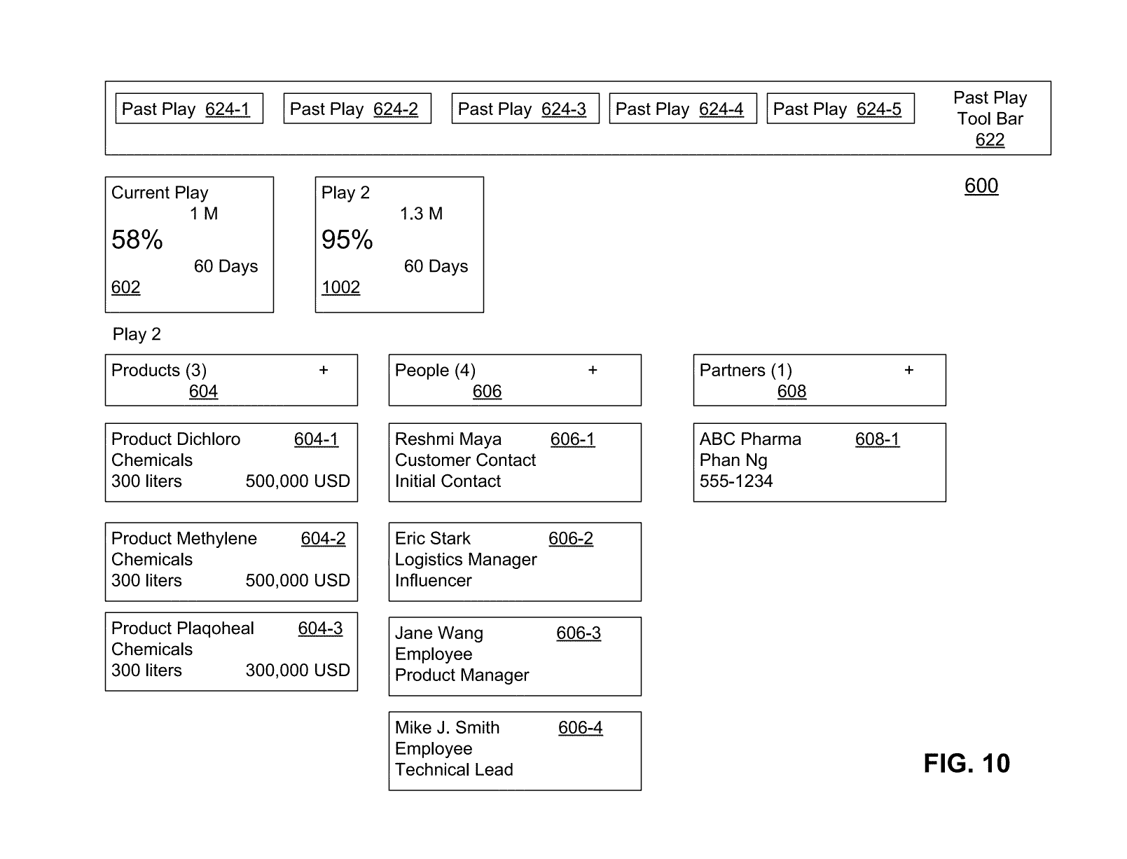

FIG. 10 is an example display 1000 of deal playbook upon selection of a third play 1002 from 900. In response to election of third play 1002, playbook engine 300 adds the new play by adding the new sales item 614-3, new people 606 if any, and any new partners 608 if any. Playbook engine 300 also changes third play 1002 to reflect the new success indicator 320, which has in the illustrative example a 95% chance of success and expected revenue of $1.3M US dollars.

FIG. 11 is a simplified diagram illustrating a process flow 1100 for calculating a score of a recommended sales item by recommendation engine 302. For simplicity and clarity, FIG. 11 is described only for recommendations of sales items, however, recommendation engines 302 can apply process flow 1100 to generate recommendations for sales teams and sales entities. At 1102, recommendation engine 302 retrieves past transactions from past transactions 330. In some embodiments, the past transactions are past transactions that are won transactions. At 1104, recommendation engine 302 assigns weights to global influencing factors 332 and contextual influencing factors 334. In some embodiments, the weights are stored in a weight table in the application logic layer 120 or the data source layer 130, and, in one embodiment, can be user adjusted. In other embodiments, the user can select the global influencing factors 332. At 1106, recommendation engine 302 analyzes past transactions for each criterion in the global influencing factors 332, and adds a weight for each factor corresponding to the transaction. At 1108, recommendation engine 302 generates a score by adding the weights for each favorable presence of a criterion of the factors.

In some embodiments, the scoring uses contrast set learning to reduce scores based on lost opportunities. In various embodiments, the scoring uses proximity scoring. In proximity scoring, deal playbook 231 can maintain a proximity table in data source layer 130 or application logic layer 120 to store proximity relationships of field values of the global influencing factors 332 and contextual influencing factors 334. The proximity can be more than physical distance of field values.

In various embodiments, the scores are ranked in a percentile method, such as the highest score receiving a 100% score and each of the subsequent scores being relatively calculated against the highest score. In other embodiments, the scores are ranked by the top ‘n’ sales items and rendered to the user. Other sales items are not rendered or available for access by the user.

FIG. 12 is a simplified diagram illustrating a process flow 1200 for calculating success indicator 320 by predictive analysis engine 240. At 1202, predictive analysis engine 240 retrieves past transactions 330. In some embodiments, the past transactions 330 are won transactions and lost transactions. At 1204, predictive analysis engine 240 assigns weight based on global influencing factors 332. In some embodiments, the weights are stored in a weight table in the application logic layer 120 or the data source layer 130, and, in one embodiment, can be user adjusted. In other embodiments, the user can select the global influencing factors 332. At 1206, predictive analysis engine 240 analyzes past won transactions and past lost transactions based on win rate in context of each criterion in the global influencing factors 332, and determines a win rate for each factor corresponding to the won transactions. At 1208, predictive analysis engine 240 generates a score by assigning a value to the win rate from the weights based on the criteria and generates success indicator 320.

In some embodiments, the scoring uses statistical learning. In various embodiments, the scoring uses interdependence between win rates. In other embodiments, the scores are determined based on comparative revenue share instead of win rate.

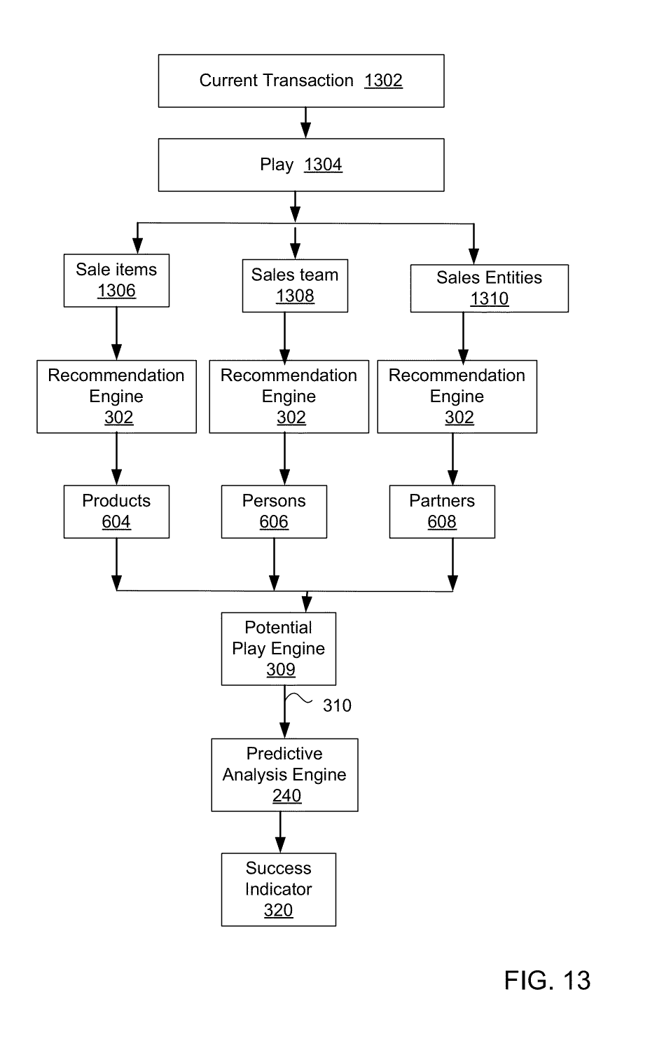

FIG. 13 is a simplified diagram illustrating a data flow 1300 for calculating success indicator 320 of a current transaction 1302 according to an embodiment. Deal playbook engine 300 evaluates current transaction 1302 as play 1304 that corresponds to one or more sales items 1306, one or more sales teams 1308 or one or more sales entities 1310 or combinations thereof. Using past transactions 330, global influencing factors 332, and contextual influencing factors 334, respective recommendation engines 302 process sales items 1306, sales teams 1308, and sales entities 1310 to generate corresponding recommendation scores that are displayed, for example, for products 604, persons 606, and partners 608, respectively, in FIGS. 6-10. The recommendation scores are provided to potential play engine 309 that generates potential play 310 based on a user selection of one or more of the recommended products 604, persons 606, and partners 608. Predictive analysis engine 240 analyzes potential play 310 based on global influencing factors 332 and past transactions 330.

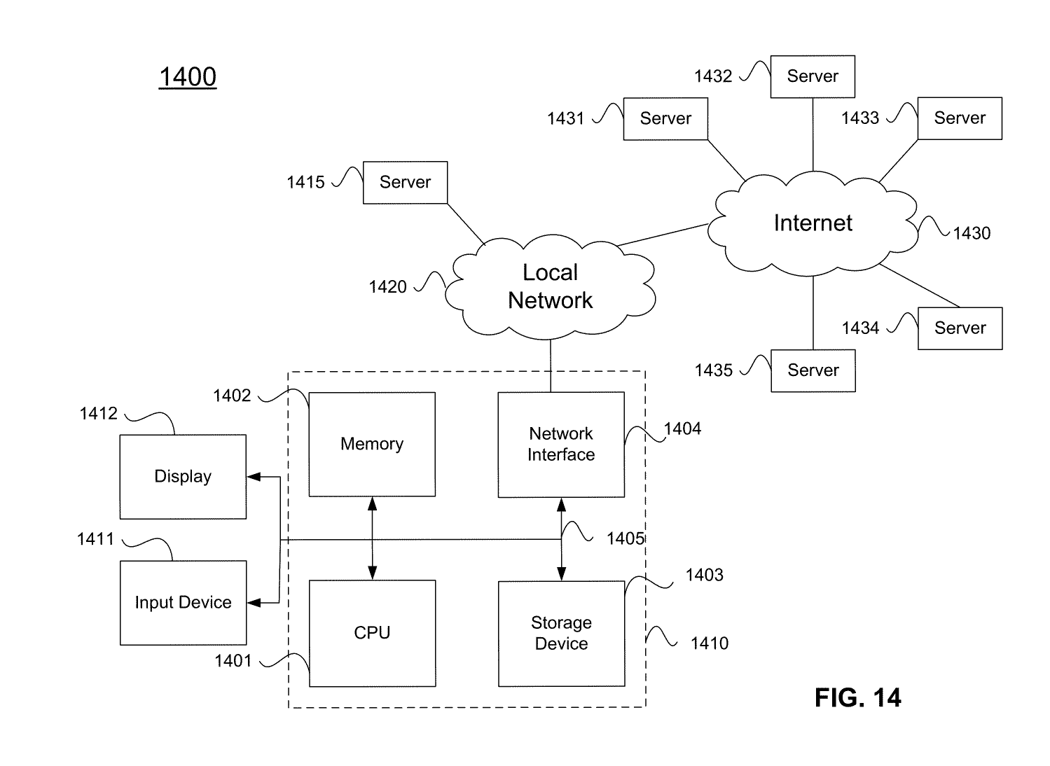

An example system 1400 is illustrated in FIG. 14. Computer system 1410 includes a bus 1405 or other communication mechanism for communicating information, and a processor 1401 coupled with bus 1405 for processing information. Computer system 1410 also includes a memory 1402 coupled to bus 1405 for storing information and instructions to be executed by processor 1401, including information and instructions for performing the techniques described above, for example. This memory may also be used for storing variables or other intermediate information during execution of instructions to be executed by processor 1401. Possible implementations of this memory may be, but are not limited to, random access memory (RAM), read only memory (ROM), or both. A storage device 1403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1403 may include source code, binary code, or software files for performing the techniques above, for example. Storage device and memory are both examples of computer readable mediums.

Computer system 1410 may be coupled via bus 1405 to a display 1412, such as a cathode ray tube (CRT) or liquid crystal display (LCD), for displaying information to a computer user. An input device 1411 such as a keyboard and/or mouse is coupled to bus 1405 for communicating information and command selections from the user to processor 1401. The combination of these components allows the user to communicate with the system, such as with user interface layer 110. In some systems, bus 1405 may be divided into multiple specialized buses.

Computer system 1410 also includes a network interface 1404 coupled with bus 1405. Network interface 1404 may provide two-way data communication between computer system 1410 and the local network 1420. The network interface 1404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1404 sends and receives electrical, electromagnetic, or optical signals that carry digital data streams representing various types of information.

Computer system 1410 can send and receive information, including messages or other interface actions, through the network interface 1404 across a local network 1420, an Intranet, or the Internet 1430. For a local network, computer system (1010 may communicate with a plurality of other computer machines, such as server 1415. Accordingly, computer system 1410 and server computer systems represented by server 1415 may form a cloud computing network, which may be programmed with processes described herein. In the Internet example, software components or services may reside on multiple different computer systems 1410 or servers 1431-1035 across the network. The processes described above may be implemented on one or more servers, for example. A server 1431 may transmit actions or messages from one component, through Internet 1430, local network 1420, and network interface 1404 to a component on computer system 1410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
generating, using a computer, recommendations of a first group of products of a plurality of products based on past transactions between a plurality of persons and a plurality of entities for the plurality of products, relationships between the persons, relationships between the entities, and relationships between the persons and the entities;
generating, using the computer, a score for each recommendation of the plurality of recommendations; and
generating, using the computer, a first success indicator of a first selected recommendation based on the score associated with the first selected recommendation.

2. The computer-implemented method of claim 1 wherein generating recommendations includes generating recommendations based on past transactions, contextual influencing factors, and global influencing factors.

3. The computer-implemented method of claim 1 wherein generating a first success indicator includes generating a first success indicator based on past transactions and global influencing factors.

4. The computer-implemented method of claim 1 wherein the scores are indicative of a probability of success of the recommendations.

5. The computer-implemented method of claim 1 wherein the past transactions include won transactions and lost transactions, and wherein generating a score includes generating a score based on win rate.

6. The computer-implemented method of claim 1 further comprising:
generating, using the computer, a second success indicator of a second selected recommendation based on the score associated with the second selected recommendation; and
displaying, using the computer, the first success indicator, the second success indicator, and the products, people and entities associated with the second recommendation.

7. The computer-implemented method of claim 1 wherein generating a score for each recommendation includes applying a predictive model to each recommendation to generate a corresponding score.

8. The computer-implemented method of claim 1 wherein the selected recommendations are sales plays.

9. A non-transitory computer readable storage medium embodying a computer program for performing a method, said method comprising:
generating, using a computer, recommendations of a first group of products of a plurality of products based on past transactions between a plurality of persons and a plurality of entities for the plurality of products, relationships between the persons, relationships between the entities, and relationships between the persons and the entities;
generating, using the computer, a score for each recommendation of the plurality of recommendations; and
generating, using the computer, a first success indicator of a first selected recommendation based on the score associated with the first selected recommendation.

10. The non-transitory computer readable storage medium of claim 9 wherein generating recommendations includes generating recommendations based on past transactions, contextual influencing factors, and global influencing factors.

11. The non-transitory computer readable storage medium of claim 9 wherein generating a first success indicator includes generating a first success indicator based on past transactions and global influencing factors.

12. The non-transitory computer readable storage medium of claim 9 wherein the scores are indicative of a probability of success of the recommendations.

13. The non-transitory computer readable storage medium of claim 9 wherein the past transactions include won transactions and lost transactions, and wherein generating a score includes generating a score based on win rate.

14. The non-transitory computer readable storage medium of claim 9 wherein the method further comprises:
generating, using the computer, a second success indicator of a second selected recommendation based on the score associated with the second selected recommendation; and
displaying, using the computer, the first success indicator, the second success indicator, and the products, people and entities associated with the second recommendation.

15. The non-transitory computer readable storage medium of claim 9 wherein generating a score for each recommendation includes applying a predictive model to each recommendation to generate a corresponding score.

16. The non-transitory computer readable storage medium of claim 9 wherein the selected recommendations are sales plays.

17. A computer system comprising:
one or more processors;
a software program, executable on said computer system, the software program configured to:
generate recommendations of a first group of products of a plurality of products based on past transactions between a plurality of persons and a plurality of entities for the plurality of products, relationships between the persons, relationships between the entities, and relationships between the persons and the entities;
generate a score for each recommendation of the plurality of recommendations; and
generate a first success indicator of a first selected recommendation based on the score associated with the first selected recommendation.
